(19) United States
(12) Patent Application Publication
(10) Pub. No.: US 2010/0167892 A1
(43) Pub. Date: Jul. 1, 2010

(54) Collapsible Bag for Dispensing Liquids, Method of Manufacturing, and Method of Use Thereof

(75) Inventors: Lars S. Johnson, Naperville, IL (US); James D. Ryndak, Barrington Hills, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 12/650,697

(22) Filed: Dec. 31, 2009

Related U.S. Application Data
(62) Division of application No. 11/642,219, filed on Dec. 20, 2006.

(51) Int. Cl. B31B 35/00; B31B 1/60; B31B 1/90; B31B 45/00

(52) U.S. Cl. 493/210; 493/214; 493/267; 493/467

(57) ABSTRACT

A collapsible container having at least two opposed flexible walls, an opening through which liquid can be removed, and a flange around the opening. The inner surface of each of the two sidewalls and the internal surface of the spout flange preferably have depressions and raised areas between the depressions. Typically, the depressions are not continuous and the raised areas are continuous. The depressions of one wall or flange cooperate with the depressions on the opposed wall to form liquid flow pathways when the wall or flange contacts the opposed wall. The liquid flow pathways allow liquid to pass therethrough instead of being blocked by the contact between a wall or flange and the opposed wall. A method of use and a method of making the bag are also disclosed.

### CROSS-REFERENCE TO RELATED APPLICATIONS

This application is a divisional application of U.S. application Ser. No. 11/642,219, filed Dec. 20, 2006.

### FIELD OF THE INVENTION

The invention relates to collapsible bags for dispensing liquid products, and more particularly to collapsible bags that do not trap or reduce the trapping and/or retention of liquids due to cooperating depressions in the bag sidewalls.

### BACKGROUND OF THE INVENTION

Various types of collapsible bags or containers are used for dispensing liquids. An example of these collapsible bags is the so-called “bag-in-box” commonly used in the soft drink industry to deliver drink syrup to soda fountains. A bag-in-box has a box for supporting and protecting a liquid filled bag during storage, shipment, and dispensing. Liquid contained in the bag typically will be removed through a spout accessible through a hole in the box by a vacuum pump.

Often the liquids dispensed from a collapsible bag are sensitive to contamination from air. The collapsible bags protect the liquids from air by collapsing as the bag is emptied. While use of a bag-in-box offers many advantages, a need exists for improvements in such devices. Typically, the bag collapses unevenly and folds. The folds trap liquid preventing the complete emptying of the bag. Therefore, a need exists for a bag-in-box that prevents or reduces the trapping of liquid as the sides of the bag collapse onto each other during liquid withdrawal.

Such bags may also trap liquids when the sidewalls of the bag collapse on each other and/or when a bag sidewall collapses onto the opening. Therefore, a need exists to prevent or reduce the trapping of liquid when a sidewall of a bag collapses onto the opening.

### SUMMARY OF THE INVENTION

In accordance with one aspect of the invention, a collapsible bag or container is provided. The collapsible bag is particularly suitable for use in a bag-in-box arrangement. The collapsible bag has two or more opposed flexible walls (first and second walls) and an opening through which liquid can be withdrawn from the container. The first and second walls have inner surfaces with a plurality of spaced apart depressions and raised areas between depressions. The plurality of depressions are discontinuous. Thus, typically the plurality of depressions in one wall cannot form a flow pathway on the surface of the sidewalls by themselves. However, the depressions of the first wall cooperate with the depressions of the second wall to form liquid flow paths when the first wall contacts the second wall. The liquid flow paths allow liquid to pass therethrough towards the opening. In one embodiment, the depressions are discontinuous and the raised areas are continuous.

In accordance with another aspect of the invention, a collapsible container is provided. The collapsible container has two or more opposed flexible walls (first and second walls) and an opening through which liquid can be withdrawn from the container. The first and second walls have inner surfaces with a plurality of spaced apart discontinuous depressions and continuous raised areas between depressions. The depressions of the first wall cooperate with the depressions of the second wall to form liquid flow paths when the first wall contacts the second wall. The liquid flow paths allow liquid to pass therethrough. One or both of the walls lack liquid flow pathways on their interior surface.

In accordance with another aspect of the invention, a collapsible container has two or more opposed, flexible sidewalls, an opening through which liquid can be withdrawn and a flange for attachment of a spout. The flange has two or more opposed surfaces. One of the surfaces is flush with the inner surface of the first wall of the container. The other flange surface and the second wall have spaced apart depressions and continuous raised areas between depressions. The flange's depressions form liquid flow pathways in cooperation with the depressions of the second wall when the other flange surface contacts the second wall of the container.

In accordance with another aspect of the invention, a method of evacuating liquid from a collapsible container is provided. The method includes providing a container containing a liquid and removing liquid from the container. The container has two flexible walls having inner surfaces with spaced apart depressions and raised areas between depressions. The depressions on one wall cooperate with the depressions of the other wall to form liquid flow paths when the two walls contact each other. During removal, the first and second walls are allowed to move inwardly and to contact each other, and liquid is allowed to flow through flow paths formed when the first and second walls contact each other.

In accordance with another aspect of the invention, a method of making a collapsible container with flow pathways is provided. The method includes providing two flexible sheet portions having a plurality of spaced apart discontinuous depressions and continuous raised areas between depressions; orienting one sheet portion over the other sheet portion to form liquid flow paths, and attaching the first and second sheet portions together along peripheral portions. The liquid flow paths include two or more depressions from the first wall and two or more of depressions from the second wall.

The invention allows liquid to drain through liquid flow paths formed when two opposed walls of a bag contact each other thereby preventing or reducing the trapping of liquid in the bag, including by folds formed when a container collapses onto itself

Similarly, the invention prevents or reduces the trapping of liquid when a wall of the container collapses onto a spout of the collapsible container because liquid flow paths are formed.

### BRIEF DESCRIPTION OF THE DRAWINGS

FIG. 1 is a perspective view of an empty collapsible bag.

FIG. 2 is a plan view of a fragment of the second wall of the collapsible bag of FIG. 1.

FIG. 3 is a fragmentary plan view of the first wall of the collapsible bag of FIG. 1.

FIG. 4 is a fragmentary plan view of the first wall overlying the second wall of FIG. 1 in a first configuration.

FIG. 4A is a fragmentary plan view of the first wall overlying the second wall of FIG. 1 in a second configuration.

FIG. 4B is a fragmentary plan view of the first wall overlying the second wall of FIG. 1 in a third configuration.

FIG. 5 is a cross-sectional view of FIG. 4

FIG. 5A is a cross-sectional view of the second wall of FIG. 4.

FIG. 6 is a cross-sectional view along line 6-6 of FIG. 1.

FIG. 6A is a perspective view of the bottom portion of a spout

FIG. 7 is a perspective view of a bottom portion of a second spout.

FIG. 8 is a plan view of a second embodiment of a pattern of depressions for one wall of a collapsible bag.

FIG. 9 is a plan view of a second embodiment of a pattern of depressions for another wall of a collapsible bag.

FIG. 10 is a plan view showing the depressions of FIG. 8 overlying the depressions of FIG. 9.

FIG. 11 is a plan view of a third embodiment of a pattern of depressions for one wall of a collapsible bag.

FIG. 12 is a plan view of a third embodiment of a pattern of depressions for another wall of a collapsible bag.

FIG. 13 is a plan view showing the depressions of FIG. 11 overlying the depressions of FIG. 12.

FIG. 14 is a plan view of a fourth embodiment of a pattern of depressions for one wall of a collapsible bag.

FIG. 15 is a plan view of a fourth embodiment of a pattern of depressions for another wall of a collapsible bag.

FIG. 16 is a plan view showing the depressions of FIG. 14 overlying the depressions of FIG. 15.

FIG. 17 is a plan view of a fifth embodiment of a pattern of depressions for one wall of a collapsible bag.

FIG. 18 is a plan view of a fifth embodiment of a pattern of depressions for another wall of a collapsible bag.

FIG. 19 is a plan view showing the depressions of FIG. 17 overlying the depressions of FIG. 18.

FIG. 20 is a plan view of an internal surface of a wall of a sixth embodiment.

FIG. 21 is a plan view of an internal surface of a wall of a seventh embodiment.

FIG. 22 is a plan view showing depressions of one wall overlying the depressions of a second wall in an eighth embodiment.

### DETAILED DESCRIPTION OF THE INVENTION

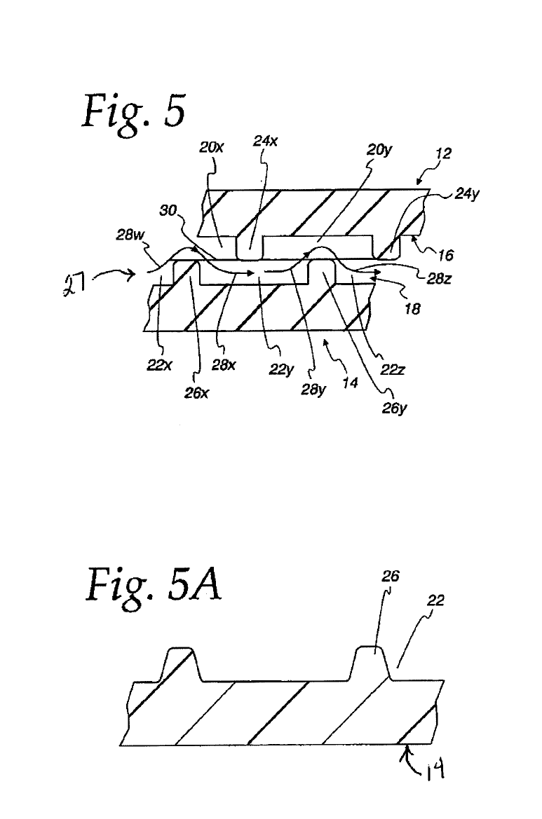

An empty collapsible container 10 is shown in FIG. 1. Collapsible container 10 has two opposed walls. As shown in FIG. 5, container 10 has first and second opposed walls 12 and 14, respectively, and a spout 54 through which liquid may be withdrawn. In use, container 10 can be oriented in any desired direction, but typically the spout is located near the bottom of the container. Container 10 is generally located within a protective box, not shown. Walls 12 and 14 are made of a flexible material that allows container 10 to collapse without causing a significant vacuum, which would slow down the rate of emptying of the container. Walls 12 and 14 are typically sheets of plastic, which are typically made from polyethylene, polypropylene, nylon, or polyester in beverage applications. Container 10 can be used for storage of juices, milk, drink syrups, chemicals, etc. Walls 12 and 14 may be made of any flexible material compatible with the liquid to be stored in container 10. Walls 12 and 14 may be multi-layered films or flexible sheets of different plastics. Container 10 may also have double walls for durability. Container 10 has a peripheral seal 15.

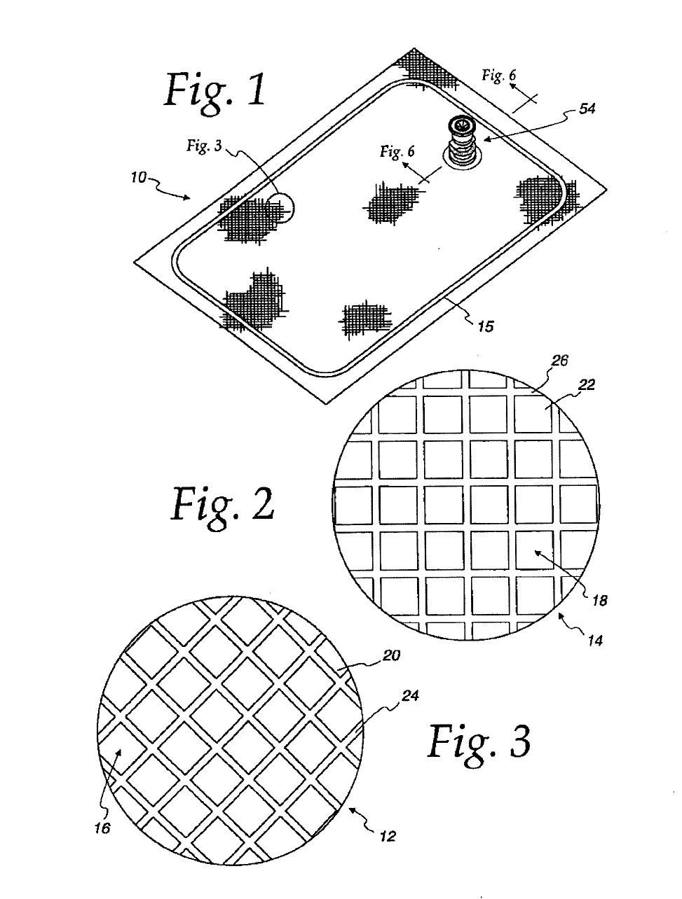

Walls 12 and 14 have inner surfaces 16 and 18, respectively. Inner surfaces 16 and 18 have spaced apart depressions 20 and 22 and raised areas 24 and 26 between depressions 20 and 22, respectively. As shown in FIG. 2, second wall 14 has discontinuous depressions 22 separated by continuous raised areas 26. As shown in FIG. 3, first wall 12 has discontinuous depressions 20 separated by continuous raised areas 24. It is not necessary for the invention that each of depressions 20 and 22 are discontinuous and discrete, and that all raised areas 24 and 26 are continuous. Raised areas 24 and 26 are raised relative to depressions 20 and 22, and depressions 20 and 22 are depressed relative to raised areas 24 and 26. It is not necessary that depressions 20 and 22 have been physically depressed or that raised areas 24 and 26 have been physically raised.

As can be seen in FIGS. 2 and 3, depressions 20 and 22 can have a diamond or square-shaped area. Square depressions 20 and 22 may have sloping or perpendicular walls resulting in a hexahedral shape. Perpendicular walls are shown in FIG. 5, while sloping walls are shown in FIG. 5A. Depressions 20 and 22 are generally hexahedral with square opposed faces as shown in FIGS. 1-4, but their shape can be any suitable shape so that when the opposed container sheets or walls are in contact, a flow path is provided. Their shape can be cylindrical, conical and frustoconical, among others.

Depressions 20 of first wall 12 cooperate with depressions 22 of second wall 14 to form liquid flow paths 27 when first wall 12 contacts second wall 14. Ordinarily, such contact in a prior art container would trap liquid. Here, as shown in FIG. 5, flow path 27 is formed by the contact of walls 12 and 14 along contact plane 30. Contact plane 30 is generally formed by a fold in container 10 when container 10 is in a collapsed or partially collapsed state. Contact plane 30 need not be straight; contact plane 30 is usually curved because folds are usually curved. The portions of raised areas 24 and 26 that contact each other are not shown, but importantly they prevent raised area 24x, for example, from significantly entering depression 22y which would impair flow path 27.

FIG. 5 is exemplary of the flow pathways of container 10 that are formed by the cooperation of sidewalls or first and second opposed walls 12 and 14. These flow pathways allow fluid in container 10 to reach spout 54 and be withdrawn therethrough. As shown in FIG. 5, flow path 27 includes flow path segments 28w, 28x, 28y and 28z, each denoted by an arrow. Flow path segment 28w goes from depression 22x to depression 20x. Flow path segment 28x goes from depression 20x to depression 22y. Flow path segment 28y goes from depression 22y to depression 20y. Flow path segment 28z goes from depression 20y to depression 22z. In effect, raised areas 26x, 26y, 24x and 24y are obstacles to the flow of liquid, but depressions 22 and 20 allow fluid to flow over and under these raised areas 26 and 24. Thus, flow path 27 has at least one depression 20 and one depression 22. Generally, at least one and possibly all flow paths 27 will have a plurality of depressions 20 and 22 from both walls 12 and 14.

Contact between walls 12 and 14 is common when container 10 is evacuated, especially when it is nearly empty. Such contact areas may occur at folds in the container. Liquid flow paths 27 allow liquid to pass therethrough toward opening 50 instead of being trapped where walls 12 and 14 contact each other as in prior art collapsible containers. “Toward opening 50” does not mean only that the straight line distance to opening 50 is shorter after passage through a flow path. It also includes the situation where there is a fold on the container and liquid that passes through a liquid flow path towards the opening results in the liquid being on the same side of the fold as the opening.

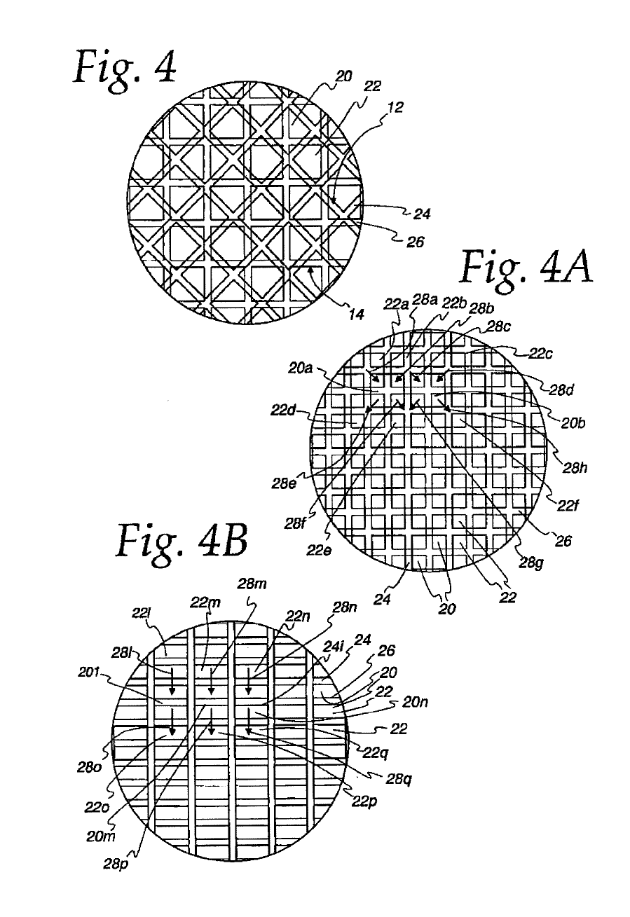

Different configurations of raised areas and depressions which provide suitable flow paths will now be discussed. FIG. 4 shows one configuration of raised areas 24 and depressions 20 of first wall 12 relative to raised areas 26 and depressions 22 of second wall 14. In FIG. 4, square depressions 20 are rotated 45.degree. relative to square depressions 22. For clarity depressions 20 are shown in bold relative to depressions 22. Depressions 20 and 22 are rotated relative to each other so that raised areas 24 and 26 cannot be in registry with each other thereby preventing the formation of flow paths 27 shown in FIG. 5, which can be toward spout 54. Depressions 20 and 22 are shown in FIG. 4 as having the same size and shape. As will be discussed later, depressions 20 and 22 may have the same shape but a different size, or different shapes.

FIGS. 4A and 4B show two different configurations of raised areas 24 and depressions 20 of first wall 12 relative to raised areas 26 and depressions 22 of second wall 14. In FIG. 4A, raised areas 24 are offset about half a square vertically and half a square horizontally from raised areas 26 as drawn on the page. In FIG. 4B, raised areas 24 are offset half a square vertically from raised areas 26 as drawn on the page.

Although FIGS. 4A and 4B have raised areas 24 and 26 of first and second opposed walls 12 and 14 having the same size and shape, the resulting flow path and flow path segments are very different. FIG. 4A shows two flow path segments 28a and 28b permitting flow into depression 20a from depressions 22a and 22b and two flow path segments 28e and 28f permitting flow out of depression 20a into depressions 22d and 22e. One of skill in the art can appreciate that liquid flow paths 27 (not shown) of FIG. 4A can be tortuous flow paths because liquid flow paths 27 can include various flow path segments 28.

Flow paths 27 (not shown) of FIG. 4B are comparatively simple. FIG. 4B shows flow path segments 28l, 28m and 28n permitting flow from depressions 22l, 22m and 22n, respectively, of second wall 14 to depressions 20l, 20m and 20n, respectively. Similarly, flow path segments 28o, 28p and 28q permit flow out of depressions 20l, 20m and 20n and into depressions 22o, 22p and 22q, respectively, of second wall 14.

As shown in FIGS. 2-4B, it is preferable that the area of depressions 20 and 22 be greater than raised areas 24 and 26 and that depressions 20 and 22 be regularly spaced to provide many suitable flow paths and to maximize the size of the flow paths. However, depressions 20 and 22 can be irregularly spaced and their shape need not be uniform throughout walls 12 and 14.

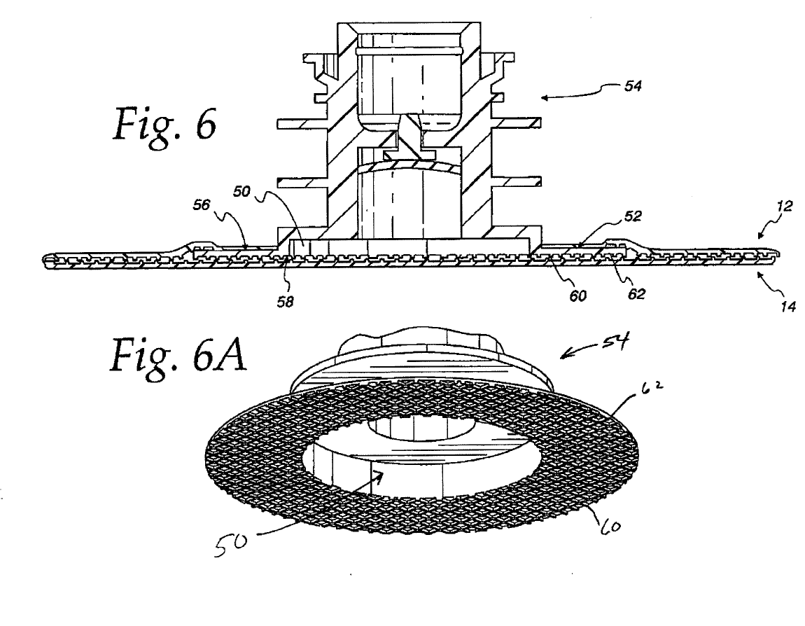

The collapsible container of FIG. 6 also has an opening 50 through which liquid can be withdrawn from the container. As illustrated, opening 50 has a spout 54 mounted therein with flange 52. Flange 52 has at least first and second opposed surfaces 56 and 58. The first flange surface 56 is flush to the inner surface of the first wall 12. As shown in FIGS. 6 and 6A, second flange surface 58 can have depressions 62 and raised areas 60. Depressions 62 cooperate with depressions 22 to form liquid flow paths when second flange surface 58 contacts second wall 14. Depressions 62 can be the same or different than depressions 20.

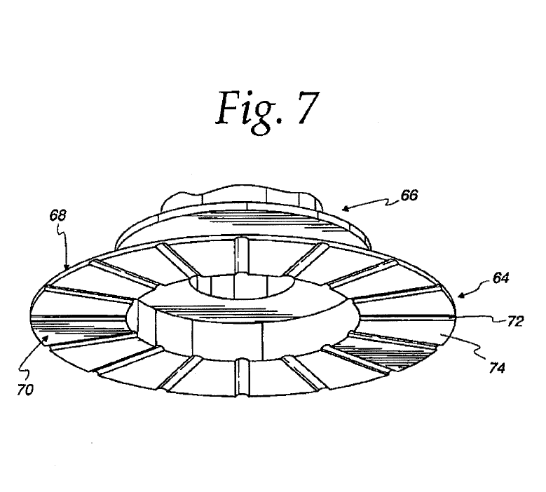

The spout flange need not have depressions. As shown in FIG. 7, a spout 66 includes a flange 64, a first surface 68, and a second surface 70 opposed from second surface 70. Second surface 70 is depicted with sixteen flow pathways 72 and sixteen raised areas 74. Alternatively, the flange need not have depressions or flow pathways (not shown).

Spouts 54 and 66 are typically made of polyethylene, but other suitable materials including various plastics may be used as desired. Flanges 52 and 64 may also have cross-bars (not shown) over the central opening to prevent blockage of the opening.

It is to be understood that in each of the following embodiments, only a portion of the opposed walls are illustrated and the depressions and raised areas are located on the internal surfaces of the walls.

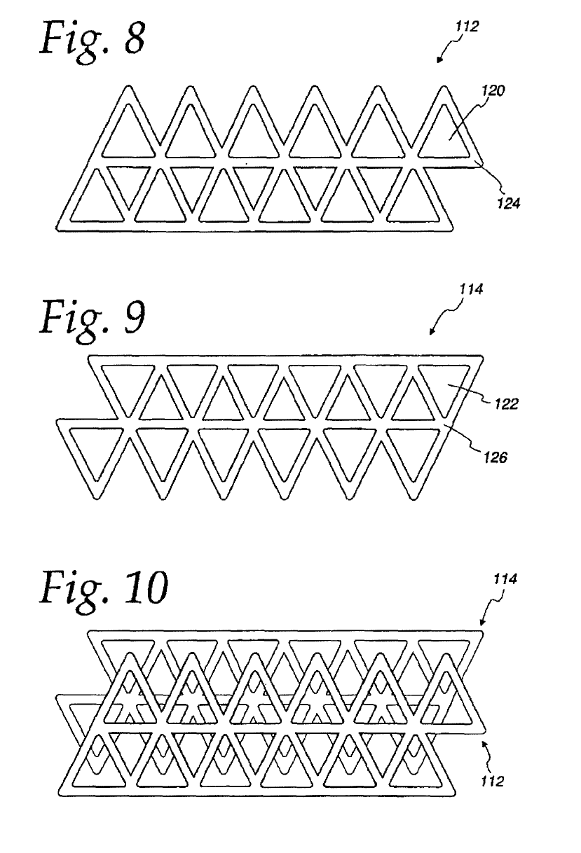

Additional embodiments with different patterns of depressions will now be discussed. In FIGS. 8-10, first wall 112 has depressions 120 and raised areas 124, and second wall 114 has depressions 122 and raised areas 126. However, as shown in FIG. 10, depressions 120 are offset and are rotated 180.degree. relative to depressions 122. Depressions 120 and 122 have a triangular area.

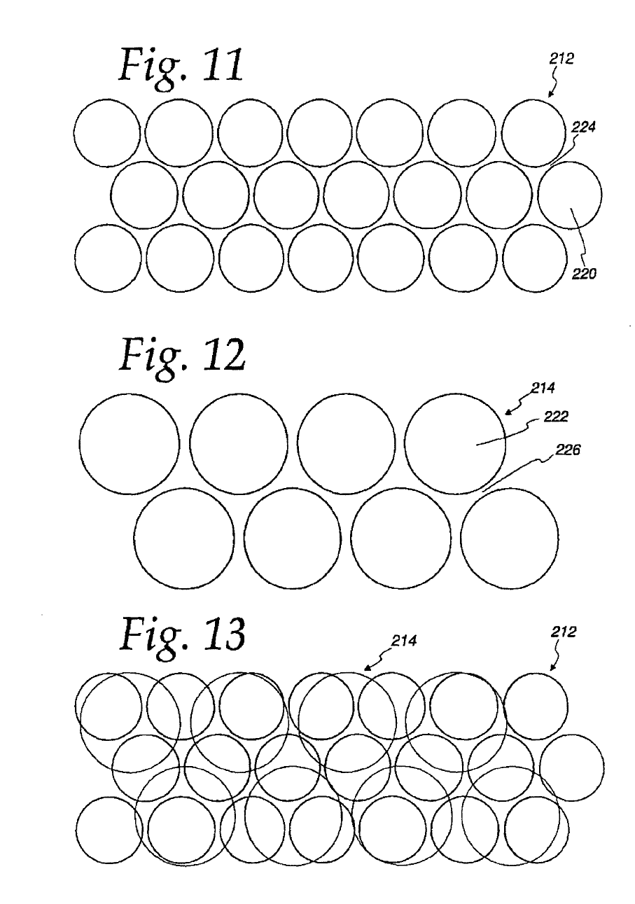

In another embodiment, shown in FIGS. 11-13, depressions 220 and 222 have a circular area. Depending on whether the walls of depressions 220 and 222 are sloping or perpendicular, depressions 220 and 222 can be frustoconical or cylindrical. Depressions 220 and 222 have different diameters to prevent excessive registry of raised areas 224 and 226 of first and second walls 212 and 214, respectively. As illustrated in FIG. 13, depressions 220 are located internally on the top sheet and depressions 222 are located internally on the lower sheet, hence depressions 222 are drawn with narrower lines in FIG. 13 for clarity.

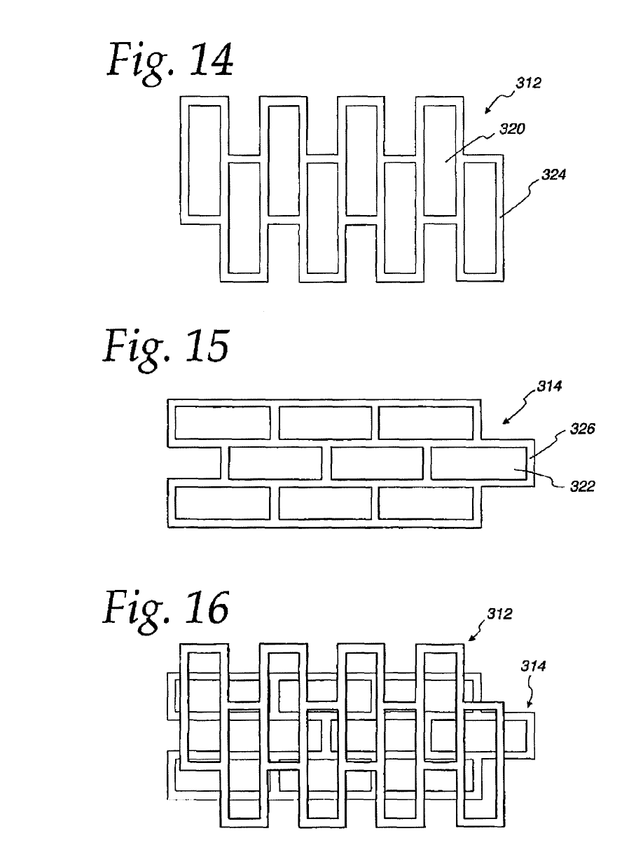

In another embodiment, shown in FIGS. 14-16, depressions 320 and 322 have a rectangular area. Depressions 320 and 322 have the same shape, but are rotated 90.degree. to ensure liquid flow paths when walls 312 and 314 contact each other. However, the relatively narrow width of depressions 320 and 322 and relatively large width of raised areas 324 and 326 is not preferred, because it results in excessive registry of raised areas 324 and 326.

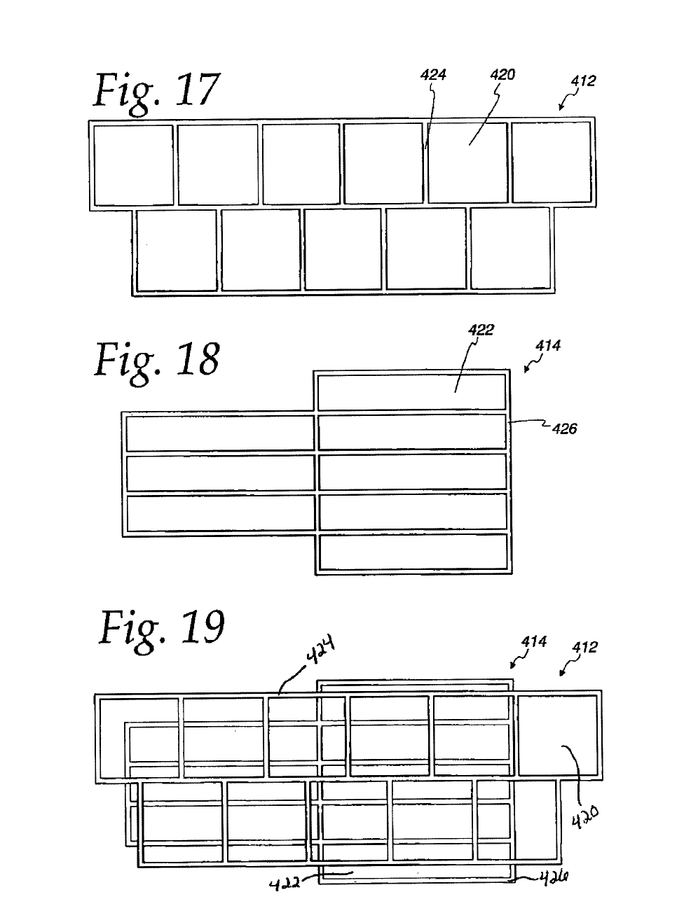

In another embodiment, shown in FIGS. 17-19, first wall 412 has depressions 420 which have a square area and raised areas 424, and second wall 414 has depressions 422 which have a rectangular area and raised areas 426. Depressions 420, if configured with sloping sidewalls, form quadrilateral frustums (apex-truncated square pyramids). Both the size and shape of depressions 420 and 422 are different. In this embodiment, raised areas 424 and 426 are relatively narrow, to provide larger flow pathways from the cooperation of the two opposed containers.

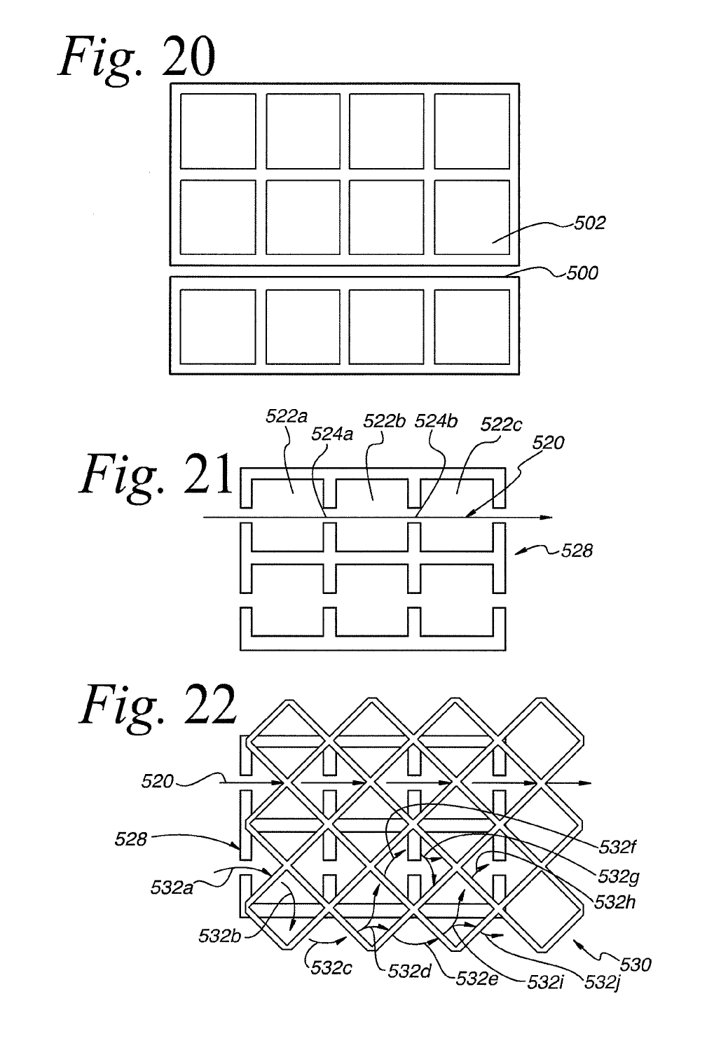

The walls of the collapsible container may, in addition to depressions, have continuous flow pathways or channels. In FIG. 20, a continuous flow pathway 500 is provided between two otherwise adjacent rows of depressions 502. Continuous flow pathways 500 may be separated by one, two or more rows of depressions 502, for example. Continuous flow pathways may extend from the peripheral seal on one side to the peripheral seal on the other side of the container, if desired.

In FIG. 21, continuous flow pathway 520 is formed by passages 524a and 524b between depressions 522a, 522b and 522c. Continuous flow pathway 520 may connect just a few depressions 522 or many depressions 522. Continuous flow pathways 500 and 520 are not necessary to the invention.

If present, continuous flow pathways 500 and 520 can be on both walls of a container. However, as shown in FIG. 22, continuous flow pathway 520 is limited to wall 528 and is absent from wall 530, which as illustrated is similar to wall 14 previously described. Cooperating flow pathways are also provided between walls 528 and 530 in a manner described with respect to FIGS. 1-5, as indicated by arrows 532a-j, as well as along flow pathway 520.

Continuous flow pathways on one wall do not need a continuous flow pathway on the other wall to cooperate to form liquid flow paths. However, if not properly configured, the raised areas of continuous flow pathways can interfere with each other when the continuous flow pathways of one wall interlock with a raised area of the other wall. In accordance with the invention, cooperation between the depressions 20 and 22, for example, of two contacting walls is required because raised areas 24 and 26 are obstacles to liquid flow. In accordance with the invention, depressions 20 and 22 on one wall do not interlock with respective raised areas 26 and 24 of the other wall, as described earlier.

It is to be understood that the depressions are not limited to any particular shape. Furthermore, the depressions can be different from one wall to the other and can even be different or vary on one wall. The depressions are preferably large relative to raised areas so as to maximize the flow path size and number. The depressions should not be so wide that depressions on one wall tend to collapse onto the raised areas of the opposed walls under normal operating conditions because liquid flow paths would not be formed or would be impeded. Similarly, raised areas cannot be so narrow that they tend to collapse. The height of the raised areas over the depressions can be, for example, about 0.005 inches. Typically, the dimensions of the depressions will be greater than the area and/or width of the raised lines or areas and the depressions will typically be in the range of from about 0.03 to about 0.5 inches or more or less as otherwise desired. The depressions can have a depth as desired and typically will be in the range of from about 30 to about 500 microns or more in depth. The width of the raised areas typically will be in the range of from about 0.01 inches to about 0.1 inches. One of skill in the art would be capable of varying the shape, size, and orientation of depressions according to the bag material, the intended use of the bag and other considerations, without departing from the scope of the invention.

The depressions may be located on a central portion of the collapsible bag. Preferably, the depressions are located throughout the inner surfaces of the collapsible container. For best sealing, it is generally preferred not to have depressions on walls 12 and 14 at peripheral seal 15 other or where flange 52 seals to first wall 12.

### Method of Evacuating Liquid From A Collapsible Container

A method of evacuating liquid from a collapsible container is provided. The method includes providing a container having at least first and second flexible walls and containing a liquid. The first and second walls have inner surfaces with spaced apart depressions and areas between depressions, such as previously described including with respect to FIGS. 1-22. Next, liquid is removed from the container. During removal of the liquid, the first and second walls are allowed to move inwardly and to contact each other to form liquid flow paths by cooperation between the depressions of the first wall and the depressions of the second wall. During removal, liquid is allowed to pass through the liquid flow paths towards the opening.

The method can also include forming discontinuous depressions on the first and second sheet portions or making continuous raised areas on the first and second sheet portions. The depressions may have a shape selected from the group consisting of cylindrical, hexahedral, conical and frustoconical on the first and second sheet portions.

The method may also include providing a flange for attachment of a spout and attaching the flange to the inner surface of the first sheet portion along a first flange surface opposed to a second opposed surface. The method can also include providing liquid flow pathways on the second flange surface or providing spaced apart depressions and continuous raised areas between depressions on the second surface of the flange so that the depressions of the second surface form liquid flow pathways with the depressions of the second sheet portion when the second surface contacts the second sheet portion.

### Method of Forming a Collapsible Container

A method of forming a collapsible container with flow pathways is provided. First and second flexible sheet portions are provided, typically as a single web or as two webs and configured in a manner as previously described, such as with respect to FIGS. 1-22. The depressions and raised area can be formed by any suitable method using any suitable equipment. For example, the web or webs are mechanically or ultrasonically embossed to form spaced apart depressions and areas between depressions on an inner surface of the first and second walls. Preferably, the depressions are discontinuous and the raised areas are continuous. Thus, the depressions on each of the sidewalls of the bag do not provide a flow pathway along the inner surface of the bag sidewall by themselves. However, the depressions on one sidewall of the bag cooperate with the depressions on the opposed sidewall when the opposed sidewalls are in contact with each other. The depressions have a suitable shape to provide the desired flow pathways when the opposed sidewalls are in contact with each other. Typical shapes that can be utilized in accordance with the invention include, for example, rectangular (including square), cylindrical, hexahedral, conical and frustoconical. The depressions may be the same or different on both wall portions.

One sheet portion is oriented over the other sheet portion to form liquid flow paths comprising a plurality of depressions from the first sheet portion and a plurality of depressions from the second sheet portion. The first and second sheet portions are attached together along peripheral portions. The sheet portions may be attached by any suitable method. Generally, the sheets are attached by heat sealing, impulsed sealing, ultrasonic sealing, or RF sealing.

Preferably, the finished collapsible bag also has a spout. To that end, the method of making a collapsible container can include providing a flange for attachment of a spout, the flange having at least first and second opposed surfaces, and attaching the flange to the inner surface of the first sheet portion along the flange's first surface. Generally, the flange is attached around a hole provided in the first sheet for evacuating the collapsible container. The flange may be attached by any suitable method including heat sealing, impulsed sealing, ultrasonic sealing or RF sealing.

The method may also include providing liquid flow pathways on the second flange surface. Alternatively, the method may include providing spaced apart depressions and continuous areas between depressions on the second surface of the flange. The depressions of the second surface of the flange are designed to form liquid flow paths with the depressions of the second sheet portion when the flange contacts the second sheet portion. The depressions and liquid flow pathways may be provided by any suitable method including molding the flanges using molds which cause the depressions or pathways, or embossing or engraving a pre-made flange.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

We claim:

1. A method of forming a collapsible container with flow pathways comprising:
providing first and second flexible sheet portions having spaced apart depressions and raised areas between depressions;
orienting one sheet portion over the other sheet portion to form liquid flow paths comprising a plurality of depressions from the first sheet and a plurality of depressions from the second sheet; and
attaching the first and second sheets together along peripheral portions.

2. The method of claim 1 further comprising forming discontinuous depressions on the first and second sheet portions.

3. The method of claim 1 further comprising making continuous raised areas on the first and second sheet portions.

4. The method of claim 1 further comprising making depressions having a shape selected from the group consisting of cylindrical, hexahedral, conical and frustroconical on the first and second sheet portions.

5. The method of claim 1, wherein the depressions on the first sheet have substantially the same shape as the depressions on the second sheet, but differ by at least one of size and orientation.

6. The method of claim 1 further comprising:
providing a flange for attachment of a spout, the flange, having at least first and second opposed surfaces, and

7. The method of claim 6 further comprising providing spaced apart depressions and continuous raised areas between depressions on the second surface of the flange, the depressions of the second surface forming liquid flow pathways with the depressions of the second sheet portion when the second surface contacts the second sheet portion.

8. The method of claim 1 further comprising providing liquid flow pathways on the second flange surface.
